(19) United States
(12) Patent Application Publication
(10) Pub. No.: US 2024/0307927 A1
(43) Pub. Date: Sep. 19, 2024

(54) PRESSURE WASHER VEHICLE FOR CLEANING A PAVED SURFACE

(71) Applicant: Robert Head, Griffin, GA (US)

(72) Inventor: Robert Head, Griffin, GA (US)

(21) Appl. No.: 18/123,285

(22) Filed: Mar. 19, 2023

(51) Int. Cl. B08B 3/02; B05B 3/06; B60P 3/22; B60P 3/30

(52) U.S. Cl. CPC B08B 3/024; B05B 3/06; B60P 3/225; B60P 3/2265; B60P 3/30; B08B 2203/0264; B08B 2203/027

(57) ABSTRACT

A pressure washer apparatus for cleaning a paved surface includes a motor driven zero-radius turn vehicle with a rotary sprayer positioned below a body of the vehicle. A pump and a reservoir containing a fluid are coupled to the body. The pump is activatable to urge the fluid from the reservoir through the sprayer such that the fluid propels the sprayer to rotate and that the fluid is forced toward the paved surface to clean the paved surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pressure washers and more particularly pertains to a new pressure washer for cleaning a paved surface.

### (2) Description of Related Art including information disclosed under 37 CFR 1.97 and 1.98

The prior art relates to pressure washers which have a rotary sprayer through which a pump forces a fluid for propelling the sprayer to rotate and for forcing matter off of a paved surface. The prior art discloses self-propelled vehicles which include the rotary sprayer but which attach via a hose to a remote pressure washing system for urging the fluid through the sprayer. The prior art also discloses self-propelled vehicles which comprise a tank for carrying the fluid and a pump and spraying means for spraying the paved surface with the fluid.

### BRIEF SUMMARY OF THE INVENTION

An embodiment of the disclosure meets the needs presented above by generally comprising a vehicle for driving on a paved surface to be cleaned. The vehicle includes a body and a plurality of wheels with each wheel being positioned below the body. The vehicle includes a drive motor which is operatively coupled to at least one of the plurality of wheels for driving the vehicle. A sprayer is rotatably coupled to an underside of the body of the vehicle. The sprayer comprises a hub, a pair of spray pipes, and a pair of nozzles. The hub is rotationally coupled to the underside. The spray pipes are coupled to and extend outwardly from the hub. Each spray pipe is in fluid communication with the hub. Each nozzle is coupled to a distal end of one of the pair of pipes relative to the hub and is in fluid communication with an associated one of the pair of spray pipes. Each nozzle has an aperture which is oriented such that a fluid flowing outwardly therefrom propels the sprayer to rotate. The nozzles are also angled downwardly to direct the fluid toward the paved surface. A pump is mounted to the body of the vehicle and is in fluid communication with the sprayer. The pump is activatable to urge the fluid through the sprayer and out of each nozzle to forcibly spray the paved surface and with sufficient force to propel the sprayer to rotate.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a pressure washer apparatus according to an embodiment of the disclosure.

FIG. 2 is a bottom side perspective view of an embodiment of the disclosure.

FIG. 3 is a bottom view of an embodiment of the disclosure.

FIG. 4 is a front view of an embodiment of the disclosure.

FIG. 5 is an in-use partial cross section view of an embodiment of the disclosure from the direction of Arrows 5-5 in FIG. 4.

### DETAILED DESCRIPTION OF THE INVENTION

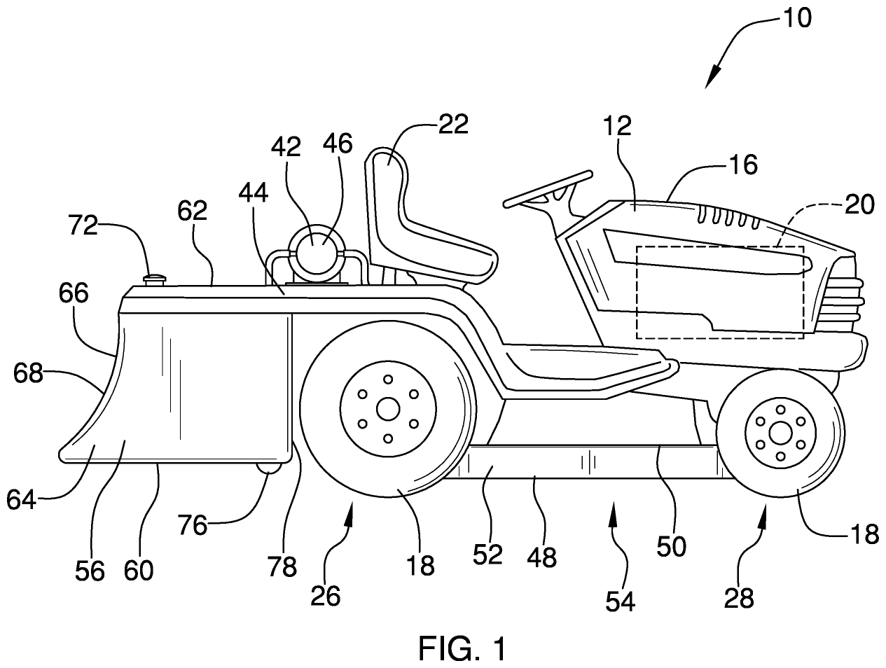

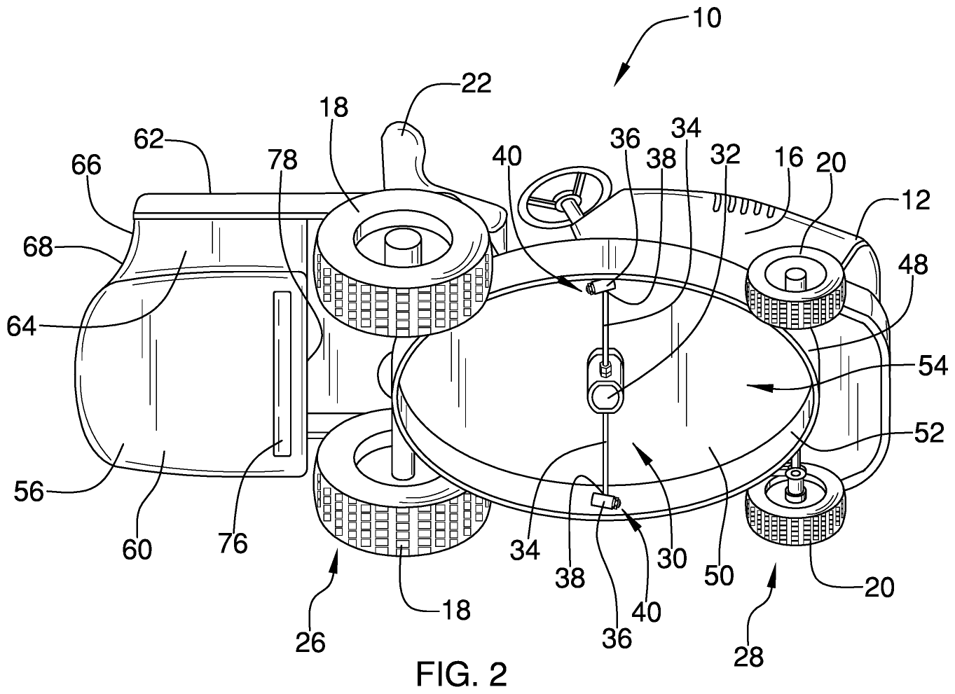

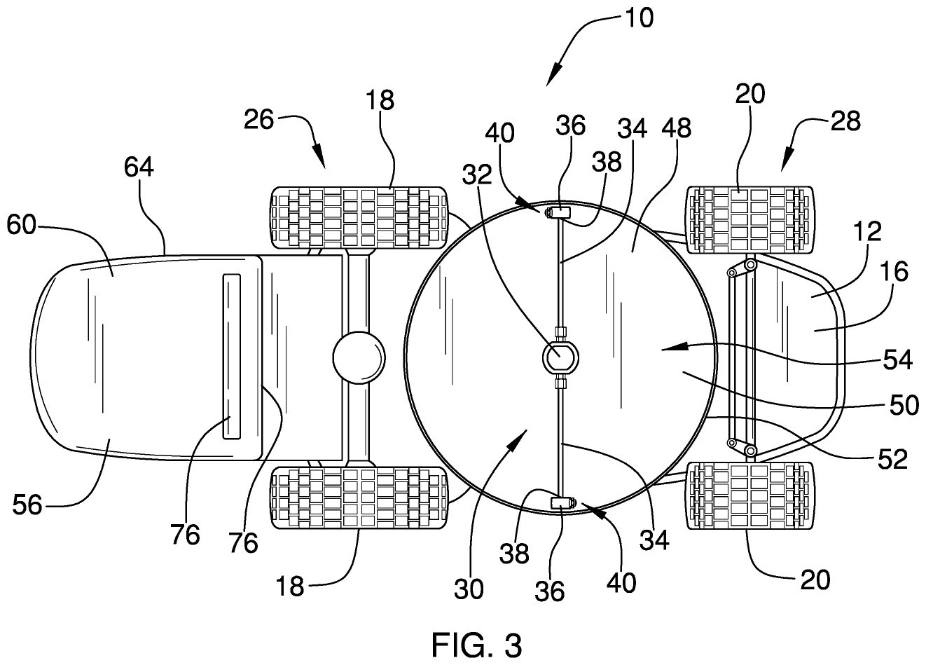

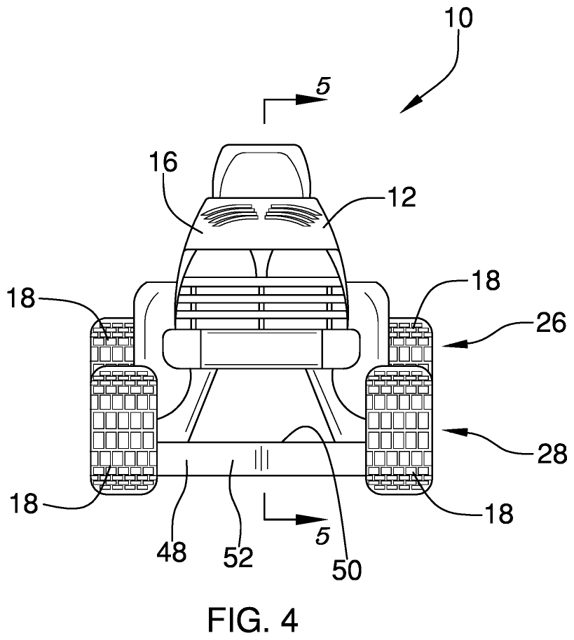

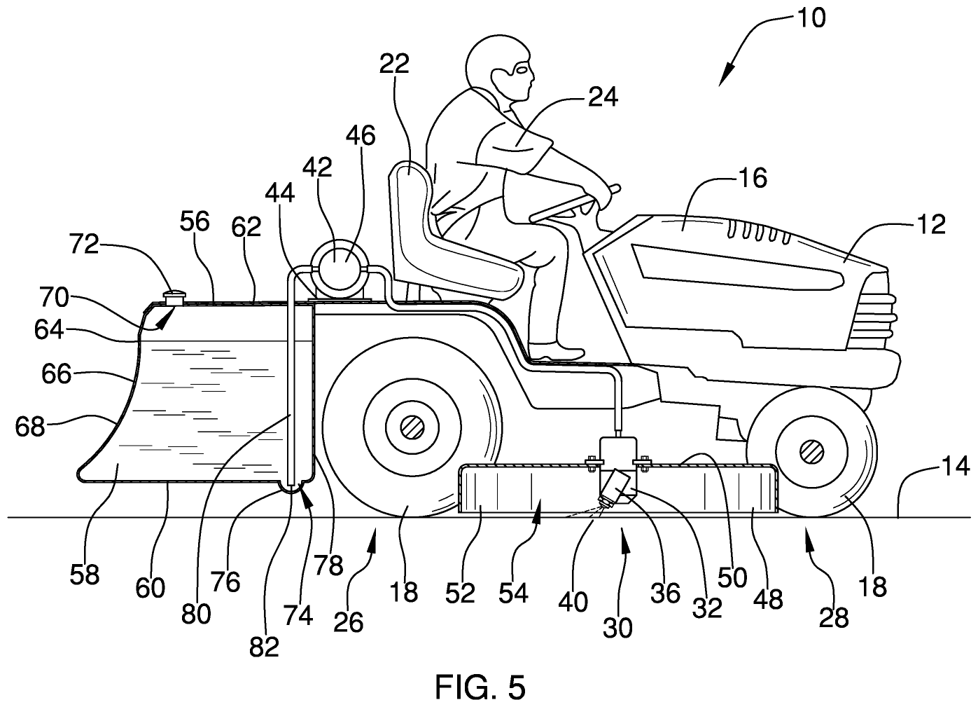

With reference now to the drawings, and in particular to FIGS. 1 through 6 thereof, a new pressure washer embodying the principles and concepts of an embodiment of the disclosure and generally designated by the reference numeral 10 will be described.

As best illustrated in FIGS. 1 through 6, the pressure washer apparatus 10 generally comprises a vehicle 12 for driving on a paved surface 14 to be cleaned. The vehicle 12 includes a body 16 and a plurality of wheels 18 which are positioned below the body 16. A drive motor 20 is operatively coupled to at least one of the plurality of wheels 18 for driving the vehicle 12. The drive motor 20 may be a combustion engine, an electric motor, or the like. The vehicle 12 is conventionally capable of driving in zero-radius turns where laterally opposing wheels 18 turn in opposite directions such that the vehicle 12 pivots around a vertical axis extending through the body 16. The vehicle 12 has a seat 22 for supporting a user 24 which is mounted to the body 16 and may be positioned above a rear pair 26 of wheels 18 of the plurality of wheels 18.

A sprayer 30 is rotatably coupled to an underside of the body 16 of the vehicle 12 for directing a fluid 58 against the paved surface 14. The sprayer 30 comprises a hub 32, a pair of spray pipes 34, and a pair of nozzles 36. The hub 32 is rotationally coupled to the underside and is positioned between the rear pair 26 of wheels 18 and a front pair 28 of wheels 18 of the plurality of wheels 18. A rotational axis of the hub 32 may be vertically oriented. Each spray pipe 34 is coupled to and extends outwardly from the hub 32. The spray pipes 34 are in fluid communication with the hub 32. Each nozzle 36 is coupled to a distal end 38 of one of the pair of pipes relative to the hub 32. Each nozzle 36 is in fluid communication with an associated one of the pair of spray pipes 34 and has an aperture 40 which is oriented such that a fluid 58 flowing outwardly therefrom propels the sprayer 30 to rotate. The nozzles 36 are also angled downwardly to direct the fluid 58 toward the paved surface 14.

A pump 42 is mounted to the body 16 of the vehicle 12 and is in fluid communication with the sprayer 30. The pump 42 is activatable to urge the fluid 58 through the sprayer 30 and out of each nozzle 36 to forcibly spray the paved surface 14 and with sufficient force to propel the sprayer 30 to rotate. The pump 42 is positioned adjacent to a top rear corner 44 of the body 16. The pump 42 may be powered by the drive motor 20 of the vehicle 12. For example, the drive motor 20 may also power a hydraulic motor, pneumatic motor, or the like to drive the pump 42. The pump 42 may also be powered by an independent motor 46, which may be a combustion engine, electric motor, or the like. The independent motor 46 may be integrated into the pump 42.

A shroud 48 is coupled to the underside of the body 16 for limiting splatter of the fluid 58 onto and around the vehicle 12. The shroud 48 has a top wall 50 and a perimeter wall 52 extending downwardly therefrom. The sprayer 30 is positioned within a cavity 54 formed by the top wall 50 and the perimeter wall 52. The perimeter wall 52 is cylindrical and is positioned adjacent to each nozzle 36.

A reservoir 56 for containing the fluid 58 is mounted to the body 16 of the vehicle 12. The pump 42 is in fluid communication with the reservoir 56 and draws the fluid 58 from the reservoir 56 for delivery to the sprayer 30 when activated. The reservoir 56 is positioned rearwardly of the body 16 and has a bottom wall 60, an upper wall 62, and a sidewall 64 extending between the bottom wall 60 and the upper wall 62. The sidewall 64 has a rear wall 66 which extends rearwardly from the upper wall 62 to the bottom wall 60. An outer surface 68 of the rear wall 66 is concavely shaped. The reservoir 56 also has an opening 70 extending therein for filling the reservoir 56. The opening 70 extends through a top wall 50 of the reservoir 56 and is positioned adjacent to the rear wall 66. A fill cap 72 is releasably coupled to the reservoir 56 for selectively covering the opening 70.

A gutter 74 is formed in a lowermost portion 76 of the bottom wall 60 for facilitating the fluid 58 pooling in the gutter 74. The gutter 74 is positioned adjacent to a front side 56 of the reservoir 56 and extends laterally with respect to the reservoir 56. An inlet pipe 80 fluidly couples the reservoir 56 to the pump 42 and has a suction end 82 positioned within the gutter 74.

In use, the vehicle 12 is driven across the paved surface 14 with the reservoir 56 containing the fluid 58. The pump 42 is activated to draw fluid 58 from the reservoir 56 and deliver it to the hub 32 of the sprayer 30. The fluid 58 is distributed to each spray pipe 34 and dispensed through the nozzles 36. The pump 42 urges the fluid 58 through the nozzles 36 with enough force to propel the sprayer 30 to rotate via jet propulsion and to force dirt, plants, and other matter off the paved surface 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pressure washer apparatus comprising:
a vehicle for driving on a paved surface to be cleaned, the vehicle including a body and a plurality of wheels, each wheel being positioned below the body, the vehicle including a drive motor being operatively coupled to at least one of the plurality of wheels for driving the vehicle;
a sprayer being rotatably coupled to an underside of the body of the vehicle, the sprayer comprising:
a hub being rotationally coupled to the underside;
a pair of spray pipes, each spray pipe being coupled to and extending outwardly from the hub, each spray pipe being in fluid communication with the hub; and
a pair of nozzles, each nozzle being coupled to a distal end of one of the pair of pipes relative to the hub, each nozzle being in fluid communication with an associated one of the pair of spray pipes, each nozzle having an aperture being oriented such that a fluid flowing outwardly therefrom propels the sprayer to rotate, each nozzle being angled downwardly; and
a pump being mounted to the body of the vehicle, the pump being in fluid communication with the sprayer, the pump being activatable to urge the fluid through the sprayer and out of each nozzle to forcibly spray the paved surface and with sufficient force to propel the sprayer to rotate.

2. The apparatus of claim 1, wherein the vehicle is capable of driving in zero-radius turns.

3. The apparatus of claim 1, wherein the vehicle has a seat for supporting a user, the seat being mounted to the body and being positioned above a rear pair of wheels of the plurality of wheels.

4. The apparatus of claim 1, wherein the hub of the sprayer is positioned between a rear pair of wheels and a front pair of wheels of the plurality of wheels.

5. The apparatus of claim 1, wherein a rotational axis of the hub is vertically oriented.

6. The apparatus of claim 1, wherein the pump is positioned adjacent to a top rear corner of the body.

7. The apparatus of claim 1, further comprising a shroud being coupled to the underside of the body for limiting splatter of the fluid onto and around the vehicle, the shroud having a top wall and a perimeter wall extending downwardly therefrom, the top wall and the perimeter wall bounding a cavity, the sprayer being positioned within the cavity.

8. The apparatus of claim 7, wherein the perimeter wall is cylindrical and is positioned adjacent to each nozzle.

9. The apparatus of claim 1, further comprising a reservoir for containing the fluid being mounted to the body of the vehicle, the reservoir being in fluid communication with the pump, the pump drawing the fluid from the reservoir and delivering the fluid to the sprayer when activated.

10. The apparatus of claim 9, wherein the reservoir is positioned rearwardly of the body, the reservoir having a bottom wall, an upper wall, and a sidewall extending between the bottom wall and the upper wall.

11. The apparatus of claim 10, wherein the sidewall has a rear wall extending rearwardly from the upper wall to the bottom wall, an outer surface of the rear wall being concavely shaped.

12. The apparatus of claim 9, wherein the reservoir has an opening extending therein for filling the reservoir.

13. The apparatus of claim 10, wherein the reservoir has an opening extending therein for filling the reservoir, the opening extending through a top wall of the reservoir and being positioned adjacent to the rear wall.

14. The apparatus of claim 9, further comprising an inlet pipe fluidly coupling the reservoir to the pump.

15. The apparatus of claim 14, further comprising a gutter being formed in a lowermost portion of the bottom wall for facilitating the fluid pooling in the gutter, the inlet pipe having a suction end positioned within the gutter.

16. The apparatus of claim 15, wherein the gutter is positioned adjacent to a front side of the reservoir and extending laterally with respect to the reservoir.

17. The apparatus of claim 12, further comprising a fill cap being releasably coupled to the reservoir for selectively covering the opening.

18. A pressure washer apparatus comprising:
a vehicle for driving on a paved surface to be cleaned, the vehicle including a body and a plurality of wheels, each wheel being positioned below the body, the vehicle including a drive motor being operatively coupled to at least one of the plurality of wheels for driving the vehicle, the vehicle being capable of driving in zero-radius turns, the vehicle having a seat for supporting a user, the seat being mounted to the body and being positioned above a rear pair of wheels of the plurality of wheels;
a sprayer being rotatably coupled to an underside of the body of the vehicle, the sprayer comprising:
a hub being rotationally coupled to the underside and being positioned between the rear pair of wheels and a front pair of wheels of the plurality of wheels, a rotational axis of the hub being vertically oriented;
a pair of spray pipes, each spray pipe being coupled to and extending outwardly from the hub, each spray pipe being in fluid communication with the hub; and
a pair of nozzles, each nozzle being coupled to a distal end of one of the pair of pipes relative to the hub, each nozzle being in fluid communication with an associated one of the pair of spray pipes, each nozzle having an aperture being oriented such that a fluid flowing outwardly therefrom propels the sprayer to rotate, each nozzle being angled downwardly;
a pump being mounted to the body of the vehicle, the pump being in fluid communication with the sprayer, the pump being activatable to urge the fluid through the sprayer and out of each nozzle to forcibly spray the paved surface and with sufficient force to propel the sprayer to rotate, the pump being positioned adjacent to a top rear corner of the body;
a shroud being coupled to the underside of the body for limiting splatter of the fluid onto and around the vehicle, the shroud having a top wall and a perimeter wall extending downwardly therefrom, the top wall and the perimeter wall bounding a cavity, the sprayer being positioned within the cavity, the perimeter wall being cylindrical and being positioned adjacent to each nozzle;
a reservoir for containing the fluid being mounted to the body of the vehicle, the reservoir being in fluid communication with the pump, the pump drawing the fluid from the reservoir and delivering the fluid to the sprayer when activated, the reservoir being positioned rearwardly of the body, the reservoir having a bottom wall, an upper wall, and a sidewall extending between the bottom wall and the upper wall, the sidewall having a rear wall extending rearwardly from the upper wall to the bottom wall, an outer surface of the rear wall being concavely shaped, the reservoir having an opening extending therein for filling the reservoir, the opening extending through a top wall of the reservoir and being positioned adjacent to the rear wall;
an inlet pipe fluidly coupling the reservoir to the pump;
a gutter being formed in a lowermost portion of the bottom wall for facilitating the fluid pooling in the gutter, the inlet pipe having a suction end being positioned within the gutter, the gutter being positioned adjacent to a front side of the reservoir and extending laterally with respect to the reservoir; and
a fill cap being releasably coupled to the reservoir for selectively covering the opening.
